(19) United States
(12) Patent Application Publication
(10) Pub. No.: US 2005/0185565 A1
(43) Pub. Date: Aug. 25, 2005

(54) Optical pickup device

(75) Inventors: Yuichi Mizuuchi, Tokorozawa-shi (JP); Hirokatsu Nagatake, Tokorozawa-shi (JP); Taichi Akiba, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 11/060,780

(22) Filed: Feb. 18, 2005

(30) Foreign Application Priority Data
Feb. 20, 2004 (JP) P2004-43801

(51) Int. Cl. G11B 7/08

(52) U.S. Cl. 369/121; 372/36; 257/712

(57) ABSTRACT

An information recording/reproducing apparatus has an LD for emitting a light beam and an optical member for irradiating an optical disc with the emitted light beam. The LD includes a stem having a first face and a second face, a heat sink joined to the first face, a lead penetrating the first and second faces, and a chip conductively attached to one end of the lead. The heat sink has an inner radius part in which an opening for housing one end of the lead and the chip is formed, and an outer radius part provided on the side opposite to the opening.

### BACKGROUND OF THE INVENTION

1. Field of the Invention

The present invention relates to a technical field of an optical pickup device for irradiating an information recording medium with a light beam.

2. Description of the Related Art

Hitherto, there is a known optical pickup device of this kind having a light emitting device for emitting a light beam and an optical member for irradiating an information recording medium with the emitted light beam (refer to, for example, Japanese Patent Application Laid-open No. 2001-176106, page 4, FIG. 1). The disclosure of the corresponding U.S. Pat. No. 6,714,495B2 is incorporated by reference in its entirety.

Concretely, a conventional light emitting device has a disc-shaped stem, a lead penetrating the stem, a chip which is made conductive at one end of the lead, and a cap for protecting the one end of the lead and the chip.

In the conventional optical pickup device, however, the cap has to be attached to protect the one end of the lead and the chip, making designing difficult at the time of miniaturizing the device.

### SUMMARY OF THE INVENTION

The present invention has been achieved in view of the circumstances and an object of the invention is to provide an optical pickup device capable of protecting a lead and a chip of a light emitting device without requiring a cap for protection.

The invention according to claim 1 relates to an optical pickup device comprising a light emitting device for emitting a light beam and an optical member for irradiating an information recording medium with said emitted light beam,
wherein said light emitting device has a base part having a first face and a second face, a heat sink joined to said first face, a lead penetrating said first and second faces, and a chip conductively attached to one end of said lead, and
said heat sink has an inner radius part in which an opening for housing one end of said lead and said chip is formed, and an outer radius part provided on the side opposite to said opening.

### BRIEF DESCRIPTION OF THE DRAWINGS

FIG. 1 is a perspective view of an information recording/reproducing apparatus according to an embodiment of the invention;

FIG. 2 is a perspective view of a light emitting device of the information recording/reproducing apparatus shown in FIG. 1; and

FIG. 3 is a perspective view of the light emitting device of the information recording/reproducing apparatus shown in FIG. 1.

### DETAILED DESCRIPTION OF THE PREFERRED EMBODIMENTS

A preferred embodiment of the invention will be described hereinbelow with reference to the drawings. The following embodiment relates to the case where an optical pickup device of the invention is applied to, for example, an information recording/reproducing apparatus.

Concretely, the information recording/reproducing apparatus in the embodiment records or reproduces information by irradiating, with a light beam, an information recording medium (hereinbelow, simply called an “optical disc”) such as a CD (Compact Disc), an MD (Mini Disc), an MO disc (Magneto Optical Disc), a DVD (Digital Versatile Disc), or any other large-capacity discs.

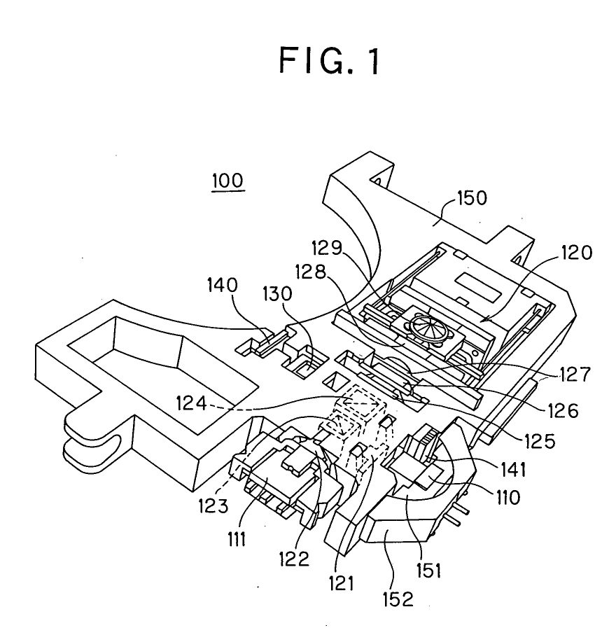

The configuration of the information recording/reproducing apparatus in the embodiment will be described with reference to FIG. 1. FIG. 1 is a perspective view of the information recording/reproducing apparatus in the embodiment.

An information recording/reproducing apparatus 100 in the embodiment includes: LDs (Laser Diodes) 110 and 111 as an example of a light emitting device for emitting a light beam; an optical member 120 for irradiating a not-shown optical disc with the light beams emitted from the LDs 110 and 111; PDs (Photo Detectors) 140 and 141 for receiving the light beam incident via the optical member 120; and a frame 150 for supporting the members, as shown in FIG. 1.

The LD 110 generates, for example, a laser beam having a short wavelength (such as 650 nm) for a DVD and emits the generated light beam to the optical member 120. As described above, the light beam emitted from the LD 110 is used for recording or reproducing information. The configuration of the LD 110 will be described hereinbelow.

The LD 111 generates, for example, a laser beam having a long wavelength (such as 780 nm) for a CD and emits the generated laser beam to the optical member 120. The laser beam emitted from the LD 111 is used for recording or reproducing information.

The optical member 120 has gratings 121 and 122, a combined prism 123, a half prism 124, a liquid crystal plate 125, a collimator lens 126, a quarter-wave plate 127, a standing mirror 128, an objective lens 129, and a multi-lens 130 which are disposed along the optical axes of the LDs 110 and 111.

The grating 121 diffracts the light beam emitted from the LD 110, thereby splitting the light beam into, for example, the zeroth-order light beam and the ±first-order light beams, and outputs the split light beams to the combined prism 123.

The grating 122 diffracts the light beam emitted from the LD 111, thereby splitting the light beam into, for example, the zeroth-order light beam and the ±first-order light beams, and outputs the split light beams to the combined prism 123.

The combined prism 123 reflects the light beam incident from the grating 121 and outputs the reflected light beam to the half prism 124. The combined prism 123 transmits the light beam incident from the grating 122 and outputs the transmitted light beam to the half prism 124.

The half prism 124 transmits part of the light beam incident from the combined prism 123 and outputs the transmitted light beam to the liquid crystal plate 125. The half prism 124 also reflects part of the light beam incident from the combined prism 123 and outputs the reflected light beam to the PD 141.

Further, the half prism 124 reflects the light beam reflected by the optical disc and incident via the objective lens 129, standing mirror 128, quarter-wave plate 127, collimator lens 126, and liquid crystal plate 125 and outputs the reflected light beam to the multi-lens 130.

The liquid crystal plate 125 corrects wave front aberration which occurs in the light beam by causing the light beams incident from the half prism 124 to have phase differences, and emits the corrected light beam to the collimator lens 126.

The collimator lens 126 converts the light beam incident from the liquid crystal plate 125 from diverging rays to parallel rays and emits the converted light beam to the quarter-wave plate 127.

The quarter-wave plate 127 converts the light beam incident from the collimator lens 126 from linearly polarized light to circularly polarized light and emits the resultant light beam to the standing mirror 128.

The standing mirror 128 reflects the light beam incident from the quarter-wave plate 127 and passes the reflected light beam to the objective lens 129.

The objective lens 129 condenses the light beams incident from the standing mirror 128 to irradiate the optical disc with the condensed light beam.

The multi-lens 130 condenses the light beam incident from the half prism 124 to irradiate the PD 140 with the condensed light beam.

The PD 140 receives the light beam incident from the multi-lens 130, generates a light reception signal in accordance with the received light beam, and outputs the generated light reception signal to a not-shown signal processing circuit. The signal processing circuit generates an error signal for executing tracking servo and focusing servo on the basis of the light reception signal supplied from the PD 140 and decodes the information recorded on an optical disc.

The PD 141 receives the light beam incident from the half prism 124, generates a light reception signal in accordance with the received light beam, and outputs the generated light reception signal to a not-shown APC (Auto Power Control) circuit. The APC circuit controls light emission outputs of the LDs 110 and 111 on the basis of the light reception signal supplied from the PD 141.

The frame 150 has holders 151 and 152 for holding the LD 110 from the back. The inclination of the LD 110 with respect to the frame 150 is adjusted by turning the holder 151.

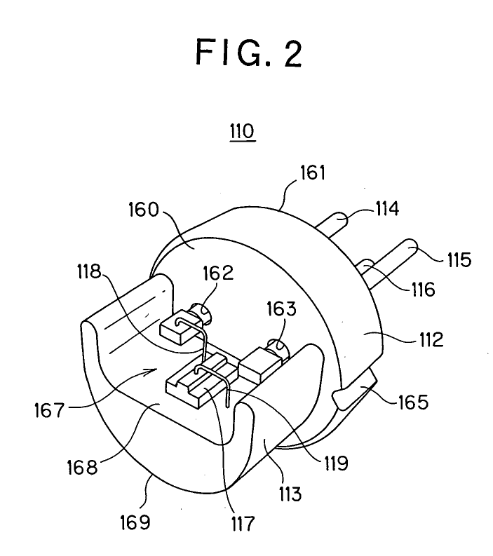

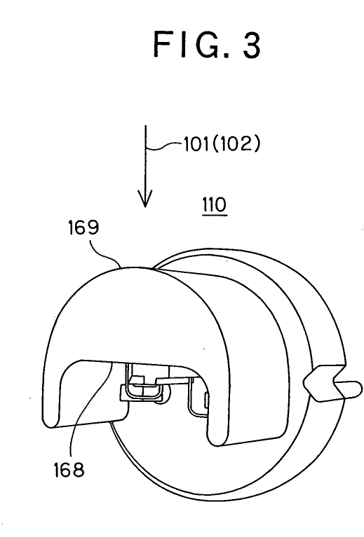

The configuration of the light emitting device in the embodiment will now be described with reference to FIGS. 2 and 3. FIGS. 2 and 3 are perspective views of the light emitting device of the information recording/reproducing apparatus shown in FIG. 1.

As shown in FIG. 2, the LD 110 in the embodiment has a stem 112 as an example of a base portion, a heat sink 113, a plurality of leads 114, 115, and 116, and a chip 117 for generating a laser beam having a predetermined wavelength. The LD 110 is supported by the frame 150 via the holders 151 and 152.

The stem 112 is made of a metal material, is formed in a disc shape, and has a first face 160 and a second face 161 as a rear face of the first face 160.

Although the stem 112 is formed in a disc shape in the embodiment, the invention is not limited to the disc shape but the stem 112 may be also formed in a D-letter shape (D cut), an I-letter shape (I cut), or the like.

In the stem 112, a plurality of small holes 162, 163, and 164 (not shown) and a plurality of notches 165 and 166 (not shown) are formed. The LD 110 is positioned with respect to the frame 150 by being attached to the holders 151 and 152 by using the notches 165 and 166 as a reference.

The heat sink 113 is formed in a U-letter shape, made of a metal material, and joined to the first face 160 of the stem 112. The heat sink 113 has an inner radius part 168 in which an opening 167 for housing one ends of each of the leads 114 and 115 and the chip 117 is formed, and an outer radius part 169 provided on the side opposite to the opening 167. The heat sink 113 dissipates heat generated in the chip 117 to the outside.

Each of the leads 114, 115, and 116 is made of a metal material and has a rod shape. The leads 114, 115, and 116 are inserted in the small holes 162, 163, and 164 in the stem 112 and penetrate the first face 160 and the second face 161 of the stem 112. One end of each of the leads 114 and 115 is projected to the opening 167 in the heat sink 113 and held by the stem 112 via a not-shown insulating material. One end of the lead 116 is joined to the heat sink 113 and held in the stem 112 via a not-shown metal material.

The chip 117 is held in the heat sink 113 so that the light emission point of the laser is positioned on the center axis of the stem 112 and is conductively attached to the one end of the lead 114 and the heat sink 113 via wires 118 and 119, respectively. Thereby, the lead 114 serves as an anode terminal and the lead 116 serves as a ground terminal.

The LD 110 is provided so that the outer radius part 169 of the heat sink 113 faces toward the direction opposite to the direction 101 of entry of dusts as shown in FIG. 3. In other words, the LD 110 is provided so that gravity 102 acts on the outer radius part 169.

Concretely, in the information recording/reproducing apparatus 100, as shown in FIG. 1, since the objective lens 129 is exposed from the surface side of the frame 150, dusts are apt to enter from the surface side of the frame 150. Therefore, the LD 110 is positioned so that the outer radius part 169 of the heat sink 113 is positioned on the surface side of the frame 150 and the inner radius part 168 of the heat sink 113 is positioned on the back side of the frame 150.

As described above, in the embodiment, the information recording/reproducing apparatus 100 has the LD 110 for emitting a light beam and the optical member 120 for irradiating an optical disc with the emitted light beam. The LD 110 has the configuration characterized by including: the stem 112 having the first face 160 and the second face 161; the heat sink 113 joined to the first face 160; the leads 114, 115, and 116 penetrating the first and second faces 160 and 161; and the chip 117 conductively attached to one end of the lead 114. The heat sink 113 has the inner radius part 168 in which the opening 167 for housing one end of each of the leads 114 and 115 and the chip 117 is formed and the outer radius part 169 provided on the side opposite to the opening 167.

With the configuration, in the embodiment, the opening 167 housing one end of each of the leads 114 and 115 and the chip 117 is formed, so that the leads 114 and 115 and the chip 117 of the LD 110 can be protected without requiring a cap for protection. Since the surface area of the heat sink 113 can be increased, the heat dissipation efficiency can be improved. Further, the number of parts can be decreased and the manufacturing cost can be reduced.

In the embodiment, the LD 110 has a configuration characterized in that the outer radius part 169 faces in the direction 101 of entry of dusts.

With the configuration, in the embodiment, the outer radius part 169 faces in the direction 101 of entry of dusts, deposition of dusts onto the leads 114 and 115 and the chip 117 can be prevented.

In the embodiment, the LD 110 has a configuration characterized in that the outer radius part 169 faces in the direction of gravity 102.

With the configuration, in the embodiment, since the outer radius part 169 faces in the direction of gravity 102, dusts can be prevented from being accumulated on the leads 114 and 115 and the chip 117.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2004-43801 filed on Feb. 20, 2004 including the specification, claims, drawings and abstract is incorporated herein by reference in its entirety.

1. An optical pickup device comprising a light emitting device for emitting a light beam and an optical member for irradiating an information recording medium with said emitted light beam,
wherein said light emitting device has a base part having a first face and a second face, a heat sink joined to said first face, a lead penetrating said first and second faces, and a chip conductively attached to one end of said lead, and
said heat sink has an inner radius part in which an opening for housing one end of said lead and said chip is formed, and an outer radius part provided on the side opposite to said opening.

2. The optical pickup device according to claim 1, wherein said light emitting device is provided so that said outer radius part faces in the direction of a space that dust invades.

3. The optical pickup device according to claim 1, wherein said light emitting device is provided so that said outer radius part faces in the direction of gravity.
